(19) United States
(12) Patent Application Publication
(10) Pub. No.: US 2009/0266979 A1
(43) Pub. Date: Oct. 29, 2009

(54) ION ATTACHMENT MASS SPECTROMETER AND ION ATTACHMENT MASS SPECTROMETRY METHOD THEREOF

(75) Inventors: Megumi Nakamura, Tama-shi (JP); Yoshiro Shiokawa, Hachioji-shi (JP); Yasuyuki Taneda, Inagi-shi (JP)

Correspondence Address: FITZPATRICK CELLA HARPER & SCINTO, 30 ROCKEFELLER PLAZA, NEW YORK, NY, 10112, US

(73) Assignee: CANON ANELVA TECHNIX CORPORATION, Kawasaki-shi (JP)

(21) Appl. No.: 12/427,000

(22) Filed: Apr. 21, 2009

(30) Foreign Application Priority Data
Apr. 25, 2008 (JP) 2008-115321

(51) Int. Cl. B01D 59/44

(52) U.S. Cl. 250/281

(57) ABSTRACT

An ion attachment mass spectrometer includes an attached ion generation unit which generates attached ions by attaching positively charged metal ions to the molecules of a measurement target substance, and a mass spectrometry unit which performs mass spectrometry of the attached ions. The mass spectrometry unit includes a mass separation chamber to select attached ions having a specific mass number from the attached ions, an ionization chamber to dissociate the attached ions having the specific mass number, and a mass analysis chamber to analyze the dissociated ions.

### BACKGROUND OF THE INVENTION

1. Field of the Invention

The present invention relates to an ion attachment mass spectrometer and an ion attachment mass spectrometry method thereof and, more particularly, to an ion attachment mass spectrometer and an ion attachment mass spectrometry method thereof, which identify and measure a gas having a specific mass number.

2. Description of the Related Art

An ion attachment mass spectrometer can perform mass analysis of a detection target gas without causing dissociation. Ion attachment mass spectrometers are reported in (1) Japanese Patent Laid-Open No. 6-11485, (2) Hodge (Analytical Chemistry vol. 48, No. 6, p. 825 (1976)), (3) Bombick (Analytical Chemistry vol. 56, No. 3, p. 396 (1984)), (4) Fujii (Analytical Chemistry vol. 61, No. 9, p. 1026 (1989)), and (5) Chemical Physics Letters vol. 191, No. 1.2, p. 162 (1992).

FIG. 3 is a view showing the typical arrangement of an ion attachment mass spectrometer.

An ion attachment mass spectrometer includes an emitter 111, reactive region 112, mass analyzer 113, mass analysis controller (including a power supply) 114, data processor 115, and detection target gas cylinder 116. The emitter 111, reactive region 112, and mass analyzer 113 are provided in a container 110. The emitter 111 is arranged at the center of the reactive region 112. The reactive region 112 is provided in the left half part of the container 110 in FIG. 3. The mass analyzer 113 is provided in the right half part of the container 110. The left side of the container 110 is defined as upstream.

The emitter 111 is made of a material containing an oxide of an alkali metal, for example, a mixture of Li oxide, Si oxide, and Al oxide. The emitter 111 emits positively charged metal ions such as Li⁺ to the space in the reactive region 112 when heated. The positively charged metal ions attach to a detection target gas that exists in the reactive region 112, thereby generating a metal-ion-attached gas. At this time, separately from the detection target gas, an inert gas such as N₂ serving as a cooling gas is introduced from a cooling gas cylinder (not shown) into the reactive region 112 to cool and stabilize the metal-ion-attached gas at the atomic level.

The metal-ion-attached gas become ions that are charged positively overall, and its mass equals the sum of the mass of the detection target gas and that of the metal ions.

For example, acetone produces CH₃COCH₃ Li⁺, which has a mass of 65 Da (dalton) that is obtained by adding 7 Da of Li to 58 Da of acetone. The mass analyzer 113 separately detects, according to the mass number, the detection target gas including ions that are charged positively overall. A measurement instrument in the mass analysis controller 114 measures the signal strength.

The measurement instrument in the mass analysis controller 114 transmits, to the data processor 115, the data of the mass number and the signal strength corresponding to it.

The data processor 115 performs various kinds of processing for the signal strength data. The most fundamental processing makes a graph by plotting the mass number along the abscissa and the corresponding signal strength along the ordinate, thereby displaying a mass spectrum. At this time, the data processor 115 also normalizes the signal strength or displays only a specific mass number as needed.

The conventional ion attachment mass spectrometer can separate a detection target gas having a specific mass number but cannot measure the components of the detection target gas and their ratio and amounts.

### SUMMARY OF THE INVENTION

The present invention has been made to solve the above-described problem, and has its object to provide an ion attachment mass spectrometer and an ion attachment mass spectrometry method, which can measure the components and component ratio of a detection target gas having only a specific mass number.

According to one aspect of the present invention, there is provided an ion attachment mass spectrometer including an attached ion generation unit which generates attached ions by attaching positively charged metal ions to molecules of a measurement target substance, and a mass spectrometry unit which performs mass spectrometry of the attached ions, the mass spectrometry unit comprising: a mass separation unit configured to select attached ions having a specific mass number from the attached ions; an ionization unit configured to dissociate the attached ions having the specific mass number selected by the mass separation unit; and a mass analysis unit configured to analyze the ions dissociated by the ionization unit.

According to another aspect of the present invention, there is provided an ion attachment mass spectrometry method of an ion attachment mass spectrometer including an attached ion generation unit which generates attached ions by attaching positively charged metal ions to molecules of a measurement target substance, and a mass spectrometry unit which performs mass spectrometry of the attached ions, comprising the steps of: causing the attached ion generation unit to generate the attached ions by attaching the positively charged metal ions to the molecules of the measurement target substance; causing the mass spectrometry unit to separate attached ions having a specific mass number from the attached ions; causing the mass spectrometry unit to dissociate the attached ions having the specific mass number separated in the step of separating the attached ions; and causing the mass spectrometry unit to analyze the ions dissociated in the step of dissociating the attached ions.

According to the present invention, it is possible to accurately identify and measure a detection target gas having a specific mass number by dissociating attached ions having a specific mass number and analyzing the dissociated ions.

Further features of the present invention will become apparent from the following description of an exemplary embodiment with reference to the attached drawings.

### BRIEF DESCRIPTION OF THE DRAWINGS

FIG. 1 is a view showing the arrangement of an ion attachment mass spectrometer according to an embodiment of the present invention;

FIGS. 2A and 2B are graphs concerning acetone used as a detection target gas; and

FIG. 3 is a view showing the typical arrangement of an ion attachment mass spectrometer.

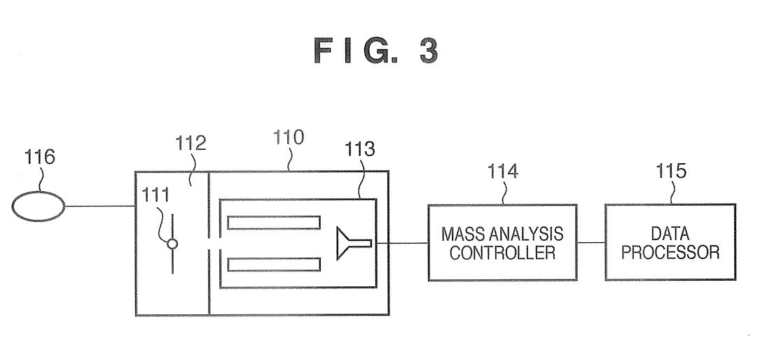

### DESCRIPTION OF THE EMBODIMENT

The embodiment of the present invention will now be described in detail with reference to the accompanying drawings.

The arrangements, shapes, sizes, compositions (materials), and layouts to be described in the following embodiments only give an outline to help in the understanding and implementation of the present invention. The numerical values and the compositions (materials) of the constituent elements are merely examples. The present invention is not limited to the embodiments to be explained below, and various changes and modifications can be made without departing from the technical scope of the appended claims.

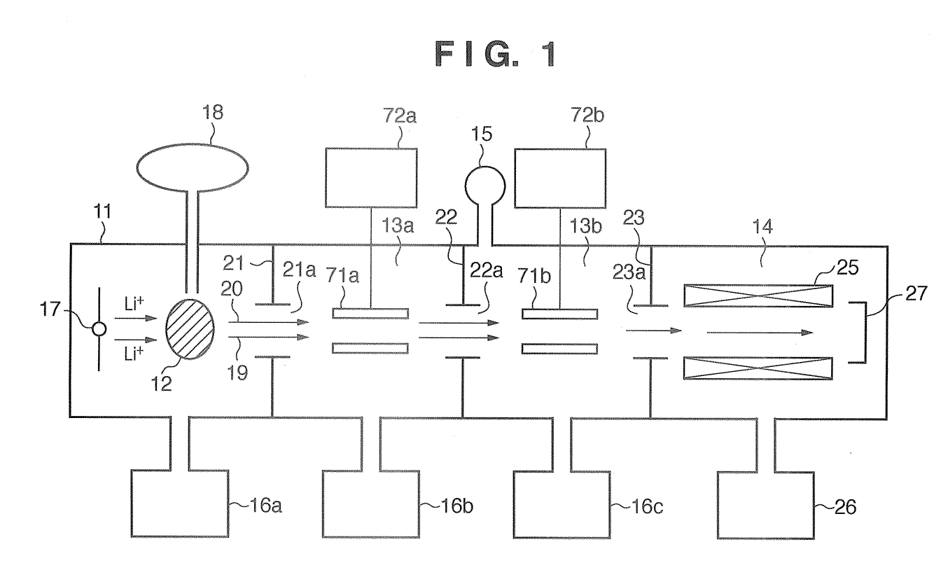

FIG. 1 is a view showing the arrangement of an ion attachment mass spectrometer according to an embodiment of the present invention.

Referring to FIG. 1, an attached ion generation chamber (serving as an attached ion generation unit) 11 generates metal ions and attaches them to the molecules of a measurement target substance, thereby generating attached ions. The attached ion generation chamber 11 includes a metal ion emitter (emitter) 17 which generates and emits metal ions, and an attachment region 12 where the metal ions attach to the molecules of a measurement target substance. A first Q-pole 71a serving as a mass separation unit is arranged in a mass separation chamber 13a. A second Q-pole 71b serving as an ionization unit, and a gas line 15 of, for example, He gas are arranged in an ionization chamber 13b. A mass analyzer 25 including a third Q-pole is installed in a mass analysis chamber 14. The mass separation chamber 13a, ionization chamber 13b, and mass analysis chamber 14 form a mass spectrometry unit. The mass analyzer 25 is included in the mass spectrometry unit.

The metal ion emitter (emitter) 17 and the attachment region 12 in the attached ion generation chamber 11 are located in the same vacuum environment Dedicated evacuation pumps 16a, 16b, 16c, and 26 are provided for the attached ion generation chamber 11, mass separation chamber 13a, ionization chamber 13b, and mass analysis chamber 14, respectively. The evacuation pumps 16a, 16b, 16c, and 26 respectively evacuate the attached ion generation chamber 11, mass separation chamber 13a, ionization chamber 13b, and mass analysis chamber 14.

In this embodiment, the metal ion emitter 17 emits, for example, positively charged lithium ions (Li⁺). A detection target gas that is a measurement target substance is introduced from a sample gas supplier 18 arranged outside to the attachment region 12 in the attached ion generation chamber 11. The emitted metal ions and the molecules of the introduced detection target gas form attached ions.

Referring to FIG. 1, arrows 19 and 20 indicate the loci of the movements of the metal ions and the attached ions. Note that the introduction position of the detection target gas need only be in the same vacuum environment in the attached ion generation chamber 11, and is not limited to the position shown in FIG. 1.

In the embodiment shown in FIG. 1 the mass separation chamber 13a includes the first Q-pole (quadrupole) 71a serving as a mechanism for selecting ions having a predetermined mass number from the attached ions. The second Q-pole 71b and the gas line 15 to supply a gas such as He gas are arranged in the ionization chamber 13b downstream. The third Q-pole is arranged in the mass analysis chamber 14 on the downstream side of the ionization chamber 13b. The attached ions having a predetermined mass number separated in the mass separation chamber 13a are transported to the second Q-pole 71b in the He gas atmosphere, thereby dissociating the attached ions from the He gas atmosphere. Then, the mass analyzer 25 including the third Q-pole can measure the fragments (dissociated ions).

When each of high-frequency power supplies 72a and 72b applies a high-frequency voltage to, for example, the four cylindrical columns of a corresponding one of the first Q-pole 71a and the second Q-pole 71b, mass separation is performed based on the difference in the orbit stability depending on mass. Alternatively, the attached ions are dissociated by making them collide against the He gas.

In the first Q-pole 71a, both a high-frequency voltage (V voltage) and a DC voltage (U voltage) are applied to adjacent cylindrical columns while setting their ratio to a specific value, thereby passing only ions having a specific mass number corresponding to the voltages.

In the second Q-pole 71b, the attached ions having a predetermined mass number, which are selected in the mass separation chamber 13a, are dissociated for qualitative measurement by making them collide against the He gas introduced from the gas line 15. As a condition to maximize the fragment generation amount, the electric field strength in the axial direction (the longitudinal direction of the second Q-pole 71b) can be selected within the range of 3.5 to 35 V/cm.

A partition 21 having a hole 21a is provided between the attached ion generation chamber 11 and the mass separation chamber 13a. The metal ions and attached ions move through the hole 21a in the partition 21.

The diameter of the hole 21a in the partition 21 is preferably 0.5 to 2 mm. If the diameter is smaller than 0.5 mm, the attached ion transmission efficiency lowers. If the diameter exceeds 2 mm, the pressure in the mass separation chamber 13a rises.

At this time, the pressure in the mass separation chamber 13a is preferably 1×10⁻² Pa or less. If the pressure exceeds 1×10⁻² Pa, the ion transmission efficiency lowers.

A partition 22 having a hole 22a is provided between the mass separation chamber 13a and the ionization chamber 13b. The metal ions and attached ions move through the hole 22a in the partition 22.

The diameter of the hole 22a in the partition 22 is preferably 4 to 8 mm. If the diameter is smaller than 4 mm, the attached ion transmission efficiency lowers. If the diameter exceeds 8 mm, the pressure in the mass separation chamber 13a rises.

The pressure in the ionization chamber 13b is preferably 5×10⁻³ to 1 Pa or less. If the pressure is lower than 5×10⁻³ Pa, the efficiency of ionization caused by collision with the He gas introduced from the gas line 15 lowers. If the pressure exceeds 1 Pa, the pressure in the mass separation chamber 13a and the mass analysis chamber 14 rises.

A partition 23 having a hole 23a is provided between the ionization chamber 13b and the mass analysis chamber 14. The diameter of the hole 23a in the partition 23 is preferably 4 to 8 mm. If the diameter is smaller than 4 mm, the ion transmission efficiency lowers. If the diameter exceeds 8 mm, the pressure in the mass analysis chamber 14 rises.

The pressure in the mass analysis chamber 14 is preferably 1×10⁻² Pa or less. If the pressure exceeds 1×10⁻² Pa, mass analysis cannot be sufficiently performed.

The mass analyzer 25 of, for example, a Q-pole (quadrupole) type is provided in the mass analysis chamber 14. The dedicated evacuation pump 26 is attached to it. A secondary electron multiplier 27 for receiving the attached ions is arranged on the right side of the mass analyzer 25 in FIG. 1.

In the mass analysis chamber 14, the mass analyzer 25 such as a Q-pole mass spectrometer using an electromagnetic force separately measures, at each mass-to-charge ratio, fragments dissociated from the attached ions having a specific mass number. The mass analyzer 25 can operate only at a pressure of 10⁻² Pa or less. Hence, a pressure difference is generated by the perforated partition 23.

In the above-described ion attachment mass spectrometer, the first Q-pole 71a to select ions having a specific mass number from the attached ions is provided on the downstream side of the attachment region 12. This mechanism enables separating ions having a specific mass number from the attached ions.

The second Q-pole 71b is successively connected on the downstream side of the first Q-pole 71a (the attached ion transportation direction is defined as downstream). This configuration enables transporting the separated attached ions having only a specific mass number to the second Q-pole 71b. The second Q-pole 71b dissociates the attached ions. Then, the third Q-pole analyzes the fragment ions, thereby measuring the components and component ratio of the detection target gas.

The ion attachment mass spectrometer according to the embodiment of the present invention includes an attached ion generation unit which generates attached ions by attaching positively charged metal ions to the molecules of a measurement target substance, and a mass spectrometry unit which performs mass spectrometry of the attached ions. The mass spectrometry unit includes a mass separation unit which selects attached ions having a specific mass number from the attached ions, an ionization unit which dissociates the attached ions having the specific mass number selected by the mass separation unit, and a mass analysis unit which analyzes the ions dissociated by the ionization unit.

The ion attachment mass spectrometry method of the ion attachment mass spectrometer includes the steps of causing an attached ion generation unit to generate attached ions by attaching positively charged metal ions to the molecules of a measurement target substance, causing a mass spectrometry unit to separate attached ions having a specific mass number from the attached ions, causing the mass spectrometry unit to dissociate the attached ions having the specific mass number separated in the step of separating the attached ions, and causing the mass spectrometry unit to analyze the ions dissociated in the step of dissociating the attached ions.

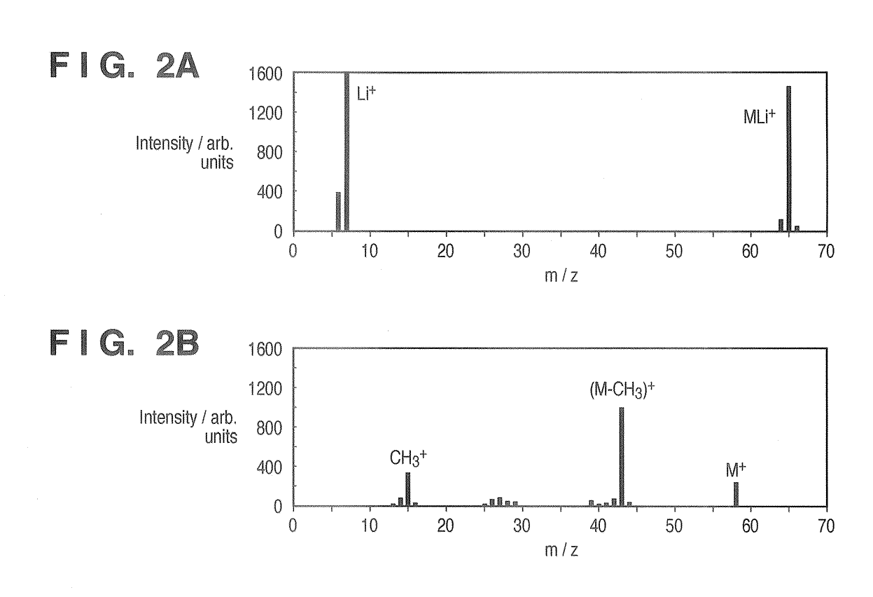

FIGS. 2A and 2B are graphs concerning acetone used as a detection target gas. FIG. 2A shows a result which is obtained by setting not to perform separation and ionization by the first and second Q-poles so as to pass all attached ions from the attached ion generation chamber 11, and analyzing the attached ions in the mass analysis chamber 14. Since attached ions are generated by attaching Li ions to acetone as the detection target gas in the attached ion generation chamber 11, peak data of Li⁺ and MLi⁺ (CH₃COCH3 Li⁺ in this case) are obtained. The mass number of the detection target gas can be detected based on these data. However, it is impossible to perform qualitative and quantitative measurements of the detection target gas. To do this, the settings of the first and second Q-poles are changed so that the first Q-pole selects attached ions having a specific mass number, and the second Q-pole dissociates the attached ions. The dissociated ions are analyzed in the mass analysis chamber 14 having the third Q-pole. FIG. 2B shows a result. As a result, the peak of CH₃⁺, the peak of M⁺ (CH₃COCH₃⁺), and the peak of (M-CH₃)⁺ (ions obtained by dissociating CH₃ from the compound M) are detected. As is apparent from this fragment pattern, the detection target gas is neither butane nor propenol having the same mass number but acetone. In FIGS. 2A and 2B, the ordinate represents the detection intensity, and the abscissa represents the mass-to-charge ratio, that is, a value obtained by dividing the mass (m) of ions by the charge number (z).

In the above embodiment, the following modifications are also possible.

As the metal ions, Li⁺ is used. However, the present invention is not limited to this, and is applicable to, for example, K⁺, Na⁺, Rb⁺, Cs⁺, Al⁺, Ga⁺, and In⁺. As the mass spectrometer, a Q-pole mass spectrometer that is a multipole mass spectrometer is used. However, the present invention is not limited to this. For example, an ion trap mass spectrometer using an external ionization method, a magnetic sector mass spectrometer, a time-of-flight (TOF) mass spectrometer, or an ion cyclotron resonance (ICR) mass spectrometer is also usable as the mass spectrometer. The mass separation chamber can also include the same mass separation unit as the mass analyzer. The constituent element of the ionization chamber is not limited to the Q-pole. Any other multipole such as a hexapole or octupole is usable. The mass analyzer can also use another multipole such as a hexapole or octupole.

As an example of a preferable form, a time-of-flight (TOF) mass spectrometer is used as the mass separation unit, a multipole such as a Q-pole is used as the ionization unit, and a time-of-flight (TOF) mass spectrometer is used as the mass analysis unit.

The detection target gas need not be gaseous from the beginning. It may be obtained by gasifying a material in a solid or liquid state in some way. The apparatus of the embodiment may be connected to another component separation apparatus such as a gas chromatograph or a liquid chromatograph to form a gas chromatograph/mass spectrometer (GC/MS) or a liquid chromatograph/mass spectrometer (LC/MS).

The present invention is applied to an ion attachment mass spectrometer. The ion attachment mass spectrometer can be connected to a gas chromatograph or a liquid chromatograph to form a gas chromatograph/mass spectrometer (GC/MS) or a liquid chromatograph/mass spectrometer (LC/MS).

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2008-115321, filed Apr. 25, 2008, which is hereby incorporated by reference herein in its entirety.

What is claimed is:

1. An ion attachment mass spectrometer including an attached ion generation unit which generates attached ions by attaching positively charged metal ions to molecules of a measurement target substance, and a mass spectrometry unit which performs mass spectrometry of the attached ions,
the mass spectrometry unit comprising:
a mass separation unit configured to select attached ions having a specific mass number from the attached ions;
an ionization unit configured to dissociate the attached ions having the specific mass number selected by said mass separation unit; and
a mass analysis unit configured to analyze the ions dissociated by said ionization unit.

2. The spectrometer according to claim 1, wherein
said mass separation unit includes a first multipole,
said ionization unit includes a second multipole, and
said mass analysis unit includes a third multipole.

3. The spectrometer according to claim 1, wherein
said mass separation unit includes a first time-of-flight mass spectrometer,
said ionization unit includes a multipole, and
said mass analysis unit includes a second time-of-flight mass spectrometer.

4. An ion attachment mass spectrometry method of an ion attachment mass spectrometer including an attached ion generation unit which generates attached ions by attaching positively charged metal ions to molecules of a measurement target substance, and a mass spectrometry unit which performs mass spectrometry of the attached ions, comprising the steps of:
causing the attached ion generation unit to generate the attached ions by attaching the positively charged metal ions to the molecules of the measurement target substance;
causing the mass spectrometry unit to separate attached ions having a specific mass number from the attached ions;
causing the mass spectrometry unit to dissociate the attached ions having the specific mass number separated in the step of separating the attached ions; and
causing the mass spectrometry unit to analyze the ions dissociated in the step of dissociating the attached ions.
